(19) United States
(12) Patent Application Publication
(10) Pub. No.: US 2019/0349561 A1
(43) Pub. Date: Nov. 14, 2019

(54) MULTI-CAMERA SCENE REPRESENTATION INCLUDING STEREO VIDEO FOR VR DISPLAY

(71) Applicant: Gordon W. Rogers, Santa Barbara, CA (US)

(72) Inventor: Gordon W. Rogers, Santa Barbara, CA (US)

(21) Appl. No.: 16/461,703

(22) PCT Filed: Nov. 20, 2018
(86) PCT No.: PCT/US18/62013

§ 371 Date: May 16, 2019

Related U.S. Application Data
(60) Provisional application No. 62/422,917, filed on Nov. 16, 2016.

(51) Int. Cl. H04N 13/156; H04N 5/225; H04N 13/239; H04N 5/232; G06K 9/00; H04N 13/344; H04N 13/194; H04N 13/111; H04M 1/02

(52) U.S. Cl. CPC H04N 13/156; H04N 5/2253; H04N 13/239; H04N 5/23238; G06K 9/00664; H04N 2013/0074; H04N 13/194; H04N 13/111; H04M 1/0264; H04N 2213/001; H04N 13/344

(57) ABSTRACT

This invention encompasses a device capable of taking two sets of videos or pictures from a slightly different perspective than the other, and using software to manipulate these two sets of media into one three-dimensional image that can be shared with others. One embodiment of the invention calls for a tray with a hand grip that holds two cell phones, and can adjust them to approximately an interpupillary distance, such that a user can take a picture with the device and have a recipient of the message view either the user or an objection the user is pointing the device at in three-dimensional view. The software also has image recognition abilities such that it can build a three-dimensional environment through the one-sided capture of an image, then pull data from an image recognition database to complete a three-dimensional representation of the object. Dual Bluetooth with close-range detection for shutter control was developed and tested successfully.

### CROSS REFERENCE TO RELATED APPLICATIONS

This application claims the benefit of U.S. Prov. Pat. App. No. 62/422,917 filed on Nov. 16, 2016, the entirety of which is hereby incorporated by reference.

### BACKGROUND OF THE INVENTION

### Field of the Invention

This invention relates generally to networks of cameras and graphics processing systems, and more particularly to a system for integrating data from two or more such devices for the purpose of abstract construction of virtual environments for subsequent user display and interaction. The invention contemplates taking stills or videos and including live steaming from two cameras, and using computer to use pattern recognition to build a three-dimensional pattern for enhanced viewing by a user.

Prior information processing systems which incorporate or use video data from individual disparate sources appears to be lacking. While many video conferencing apps exist, they are intended for remote collaboration rather than local shared and enhanced experience. The simplest form provides stereo vision (and audio), but this could be easily superseded by a new “Eyesphone” with two camera lenses, rather than the typical single camera approach currently offered in the market. The average phone unit is anticipated to have a single camera for the near term. A commercial ‘eyephone’ was produced, though its inter-ocular (IOD or Interpupillary) distance is inconsistent with that of humans: approximately 1.25 inches, while the standard human inter papillary distance is 2.6 inches. The result is that objects appear larger than they would when viewed by a person, and or could be interpreted as having been viewed from a greater distance. The parallax captured is not consistent with the distance from which the image was captured.

While many stereo cameras exist, there does not appear to be a solution that provides collaboration between users with single-aperture camera phones that allows for the merging of the data into a single data set navigable by subsequent viewers of the data as represented on conventional display means. Thus, while the various face-to-face conferences and meetings that can be held through webcams are useful, and while sending pictures and videos taken on a cell phone are interesting, these types of transmissions would be much more effective if they were more than a merely two dimensional photo or video.

Even given the eventuality of common stereo internet units, they will only add to the ease of capture and overall immersive realism of multi user video capture. Notably the profusion of multiuser games and locale identification applications such as Four-square does not anticipate scene based video collaboration in constructing renderings of the environment for subsequent use. Anticipated applications might include game development, real estate, military, medical, automotive, and training for any physical procedure, amongst others yet to be determined.

Thus there is a need for a different method or architecture for routing multiple video data streams to be merged into an aggregate or aggregates for use in gaming and display of the merged data into coherent environments for later viewing and virtual immersion into the scenes from which the original scenes were captured.

Creation of this invention solves several prior limitations. The prior art has physical limitations for merging and routing coordinated signals to and from the capturing devices and to eventual end users. This has resulted in significant technical limitations for applications of such systems.

Thus there has existed a long-felt need for an improved information processing system architecture using data from two or more capture systems within a locale.

### SUMMARY OF THE INVENTION

The current invention provides just such a solution by encompassing a device capable of taking two sets of videos or pictures from a slightly different perspective than the other, and using software to manipulate these two sets of media into one three-dimensional image that can be shared with others. One embodiment of the current disclosure calls for a tray with a hand grip that holds two cell phones, and can adjust them to approximately an interpupillary distance, such that a user can take a picture with the device and have a recipient of the message view either the user or an objection the user is pointing the device at in three-dimensional view. The software also has image recognition abilities such that it can build a three-dimensional environment through the one-sided capture of an image, then pull data from an image recognition database to complete a three-dimensional representation of the object.

Another embodiment of the current disclosure provides for an adapter that may be secured and connected to a mobile phone or other mobile device. The adapter has four cameras to provide 360 degree stereo 3D viewing with enhanced image resolution. Each camera is capable of producing a 360 View that is then merged into a stereo 3D Dataset that allows the user to ‘look around’ panning the viewer to objects in any direction from the image capture unit.

The current disclosure further provides stereo viewing environments from multi user captures. Additionally, advanced applications of the process allow for two or more users to construct key-feature-marked objects to provide fully immersive environments along a path defined by the user including scene completion of key objects recognized through automated means, including ‘Backside of objects only captured from one perspective. This makes possible multiuser scene emulation navigable for subsequent users.

Embodiments of the current disclosure use two cameras to capture images or video from slightly different locations. A computer uses pattern recognition to create a three-dimensional model based on what is captured by the camera combined with what the computer can construct from the various pattern-recognition databases. Thus, while a person may shoot or video a scene from one location, a three-dimensional representation of the entire scene will be created by the computer; thus, even the backside of objects not seen by the camera can be created. The computer will then create two separate maps, one for each eye, thereby allowing the person to truly see in 3D viewing.

For basic stereo (3-D) image capture, two separate video capture systems' files are merged using file meta data such that the beginning of the file which starts at a later time is aligned to that time based image sequence. Adjusting the two videos to only leave the overlap remaining can be accomplished by forcing both into an intermediate form that through the use of interpolation causes the frame rates (and other factors) to be similar. It is noted that not all cell service providers are aligned to the same time source and therefore the metadata can vary. This is also an issue regarding second source camera apps which may vary the frame rate according to the available light or other factors in the file that started earlier and then both subsequent sequences of images are combined into a single file for later viewing or processing to produce a single Stereo (3-D) video file. This system may include internet communication of the files either from one or both of the phones, a third or more phones or to a cloud based processing system. The video capture systems relative location and orientation are known or can be characterized from the video itself. Either metadata or scene specific triggers, such as audio track event coincidence, such as a hand clap, finger snap, music or speech can be used to align video portions of the data. As individual phone clocks may not be exactly set to the same time, direct metadata use can produce images and audio ‘Left-right’ merging that is incorrect. Metadata from two specific phones can be used subsequently if any inconsistency between the specific clocks is adjusted to align the clocks after one corrected stereo image. The reported time stamp between two phones clocks will remain consistent between those two capture units and the aligned metadata timestamps can then be used to align further images and videos.

For advanced multi-perspective scene construction, this approach can be extended to include multi-perspective scene mapping and imaging from two or more video capture systems. Key objects can be identified and marked for comparison between the relative locations within the video, and perspective can be generated algebraically to construct 3-D maps of the environment. The metadata here includes time, location and capture orientation.

For probabilistic scene completion, the discussion herein may be enhanced by including key object recognition and “backside” images made available for views not yet captured.

It is therefore an object of the current disclosure to provide an improved method for stereo video capture.

It is another object of the current disclosure to provide an apparatus for forming a fixed interpupillary distance (space between the two eyes' pupils) for two camera phones.

It is another object of the current disclosure to provide means for connecting separate camera systems via the internet.

It is another object of the current disclosure to provide scene construction means for camera systems.

It is another object of the current disclosure to allow separate camera phones' internet connection and file configurations providing stereo video from the phones independent video files.

It is another object of the current disclosure to allow virtual reality scene construction from multiple camera feeds.

It is another object of the current disclosure to allow imaged object identification to more thoroughly complete virtual reality environments through back side image additions consistent with the front side captured video when users turn their gaze to scenes walked through, but not imaged from the backside.

It is another object of the current disclosure to use video file metadata for the construction of virtual environments.

It is another object of the current disclosure to use multiple existing stereo video capture systems in collaboration to provide additional scene information for synthesis into a coherent whole.

It is a further object of the current disclosure to provide systematic routing.

In summary, there is provided an information collaboration system providing captured video or still images coordinated to construct three dimensional viewing environments. These environments can be further processed to allow for perspectives and paths of navigation not originally captured. Exiting pattern recognition algorithms may be used to supplement the images captured to allow for the completion of objects from perspectives not actually imaged.

An exemplary embodiment of the current disclosure is an apparatus for capturing stereo images comprising a mount, where the mount comprises a first rack and a second rack, where each rack comprises a retention mechanism; and a first camera and a second camera, where the first camera is secured to the first rack by the retention mechanism of the first rack, and where the second camera is secured to the second rack by the retention mechanism of the second rack, where each camera comprises a lens, where the lenses are a certain distance from each other. The distance between each rack is adjustable thereby adjusting the distance between each lens. The distance between each lens is between 65 mm and 130 mm, inclusive. Alternatively, the lenses are at a distance from each other of between 60 mm and 70 mm, inclusive. The first camera is a first mobile phone and the second camera is a second mobile phone. Alternatively, the first camera is a first 360 degree camera, and the second camera is a second 360 degree camera. Each rack has a separate rotational degree of freedom allowing each rack to rotate independently.

Another exemplary embodiment of the current disclosure is a system for generating stereo image or video files from separate capture sources comprising a capture system having a first camera and a second camera, where the capture system generates a first media and a second media, where the first media comprises image or video data from the first camera, and where the second media comprises image or video data from the second camera, a computer system comprising one or more processors executing programming logic, the programming logic configured to: recognize objects in the first media and second media and retrieving pattern recognition objects from pattern recognition databases; take the first media, second media and the pattern recognition objects, and creating a three dimensional representation of an entire scene, including both the side views of objects originally contained in the first media and second media as well as side views of objects created by the software from the pattern recognition objects; take both the side views of objects originally contained in the first media and second media as well as side views of objects created by the software from the pattern recognition objects, and combining these into two separate maps, one for each eye; identify discrepancies in the objects between the first media and second media, and correcting these discrepancies by comparing the first media and the second media; and generate an output media having a stereo image or video file, and further comprising a display system for displaying the output media. The first media comprises video data, and where the programming logic is further configured to vary the frame rate of video data within the first media based upon available light. The programming logic is further configured to create a scene through spatial map construction using the first media from both cameras. The programming logic is further configured to create a virtual reality environment through backside image additions by retrieving object recognition data from one or more object recognition databases. Each camera of the capture system is a mobile phone. Alternatively, each camera of the capture system is a 360 degree camera. The display system is a mobile phone. Alternatively, the display system is a set of goggles, where the goggles comprises a first display for displaying an image to a first eye of a user, and a second display for displaying an image to a second eye of a user. Each camera of the capture system comprises a lens, wherein the lenses are at a distance from each other of between 60 mm and 70 mm, inclusive.

A further exemplary embodiment of the current disclosure is a method of providing a three-dimensional stereo viewing experience, comprising the steps of, in order: first, securing two cameras to an adjustable mount; second, capturing two sets of pictures or videos using the cameras from adjustably different perspectives; third, transmitting the two sets of pictures or videos to a processing center; fourth, identifying temporal overlap in the two sets of pictures or videos and creating a temporal overlapped series of pictures or videos; fifth, creating a single file from the temporal overlapped series of pictures or videos; sixth, forming a single image or video file; seventh, transmitting the single image or video file to a customer. Each camera is a mobile phone. Alternatively, each camera is a 360 degree camera. The mount comprises a strap, band or bracket.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future. Furthermore, the use of plurals can also refer to the singular, including without limitation when a term refers to one or more of a particular item; likewise, the use of a singular term can also include the plural, unless the context dictates otherwise.

The presence of broadening words and phrases such as “one or more,” “at least,” “but not limited to” or other like phrases in some instances shall not be read to mean that the narrower case is intended or required in instances where such broadening phrases may be absent. Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

As used herein, the term “3D” refers to three-dimensional, for example, a 3D image would be a three-dimensional image.

There has thus been outlined, rather broadly, the more important features of the invention in order that the detailed description thereof may be better understood, and in order that the present contribution to the art may be better appreciated. There are additional features of the invention that will be described hereinafter and which will also form the subject matter of the claims appended hereto. The features listed herein and other features, aspects and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is a graphic showing an exemplary stereo or 3D image according to selected embodiments of the current disclosure.

FIG. 2 is diagram showing the geometry of a screen view of a small cube at a distance z captured by a twin camera with separation a according to selected embodiments of the current disclosure.

FIG. 3 is a perspective view of a left map and right map according to selected embodiments of the current disclosure.

FIG. 4 is a perspective view of a tripod mount with a Bluetooth trigger according to selected embodiments of the current disclosure.

FIG. 5 is a screenshot displaying a stereo image of a self-portrait using a split rack tripod mount according to selected embodiments of the current disclosure.

FIG. 6 is a perspective view of a tripod with a split rack tripod mount according to selected embodiments of the current disclosure.

FIG. 7 is a front view of a pair of individuals taking dual self images or video with approximate “true stereo” symmetry for subsequent file merging for 3-D (AKA stereo) still image or video rendering by binocular display systems into a single file, according to selected embodiments of the current disclosure.

FIG. 8 is a front view of a pair of individuals taking dual self images or video with approximate “pseudo stereo” symmetry for subsequent file merging for 3-D (AKA stereo) still image or video rendering by binocular display systems according to selected embodiments of the current disclosure.

FIG. 9 shows a dual phone mount on a tripod and an extension according to selected embodiments of the current disclosure.

FIG. 10 shows a 360 degree stereo 3D image/video capture system according to selected embodiments of the current disclosure.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

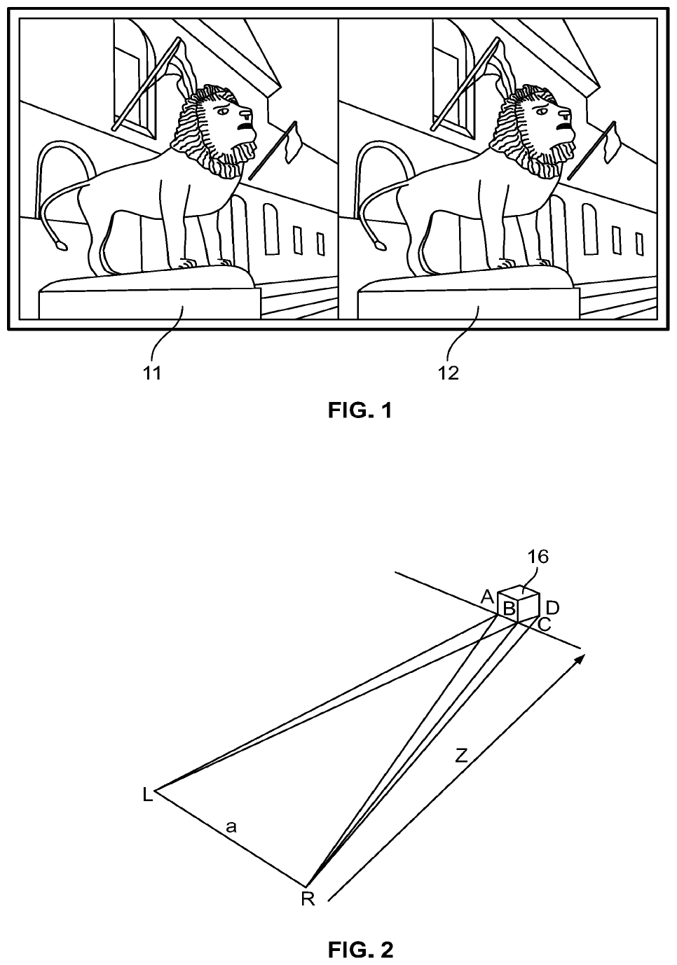

FIG. 1 is a graphic showing an exemplary stereo or 3D image according to selected embodiments of the current disclosure. Typical binocular (stereo or 3D image) is akin to looking “through” the pair of images, left image 11 and right image 12, allowing the brain to construct a single 3D image: It should be noted that not everyone can see stereo images for various reasons, some are associated with vision differences between the individual's eyes and some are not. The depth perception trait is highly developed in some individuals, but most people have “stereo vision” capabilities.

FIG. 2 is diagram showing the geometry of a screen view of a small cube 16 at a distance z captured by a twin camera with separation a according to selected embodiments of the current disclosure. Right and left eye images are shown superimposed. The right and left eyes' panels in a stereoscopic reconstruction are created by projection from the principal points of the twin recording camera. The geometrical situation is most clearly understood by analyzing how the screens are generated when a small cubical element of side length dx=dy=dz is photographed from a distance z with a twin camera whose lenses are a distance a apart.

In the left eye panel of the stereogram the distance AB is the representation of the front face of the cube, in the right eye panel, there is in addition BC, the representation of the cube's depth, i.e., the intercept on the screen of the rays from the cameras' principal points to the back of the cube. This interval computes to the first order to dz×a/z. (To simplify the account, the right and left screens are taken to be superimposed, as they would be in a 3D display with LCD goggles.) Hence the depth/width ratio of the cube's view, as embodied in its representation on the viewing screen, is r=a×dz/z×dx=a/z since dx=dz and depends solely on the distance of the target from the twin lenses and their separation and remains constant with scale or magnification changes. The depth/width ratio of the actual object, of course, is 1.00.

This stereogram with the cube, whose depth/width ratio had been captured with recording parameters a_{c} and z_{c} and embodied in the ratio BC/AB=r_{c}=a_{c}/z_{c}, is now viewed by an observer with interocular separation aₒ at a distance zₒ. An overall scale change in BC/AB does not matter, but unless rₒ=r_{c}, i.e., aₒ/zₒ=a_{c}/z_{c}. this no longer represents a cube but rather becomes, for this observer at this distance, a configuration for which R=r_{c}/rₒ; for example, whose depth is R times that of a cube.

But we also need the ability to pan in an arbitrary direction, so we insert a ‘flat’ image consistent with stereo graphic projection where in Cartesian coordinates (x, y, z) on the sphere and (X, Y) on the plane, the projection and its inverse are given by the following equations:

$$\begin{matrix}( X , Y ) = ( \frac{x}{1 - z} , \frac{y}{1 - z} ) , & Equation 1 \\ ( x , y , z ) = ( \frac{2 X}{1 + {X}^{2} + {Y}^{2}} , \frac{2 Y}{1 + {X}^{2} + {Y}^{2}} , \frac{- 1 + {X}^{2} + {Y}^{2}}{1 + {X}^{2} + {Y}^{2}} ) . & Equation 2\end{matrix}$$

For all points except the ‘south pole’:

P∈ [symbol] ⇔P′∈ [symbol] Equation 3

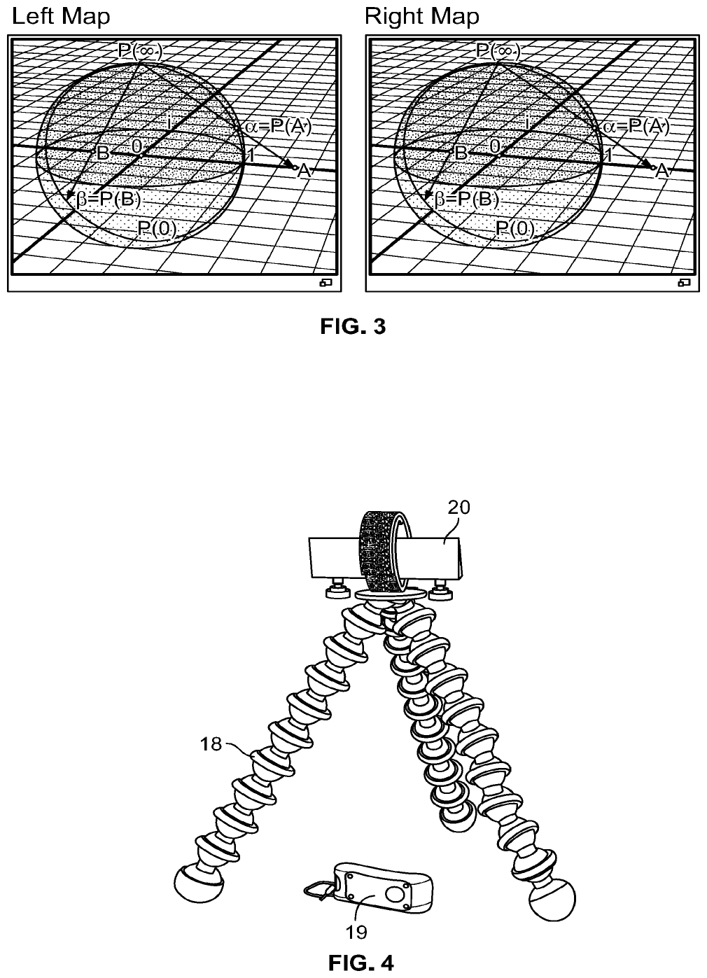

But we need two distinct maps to cover the disparities between left and right eyes when the gaze falls in a particular direction in perceived three-space, generating (x₂, y₂,z₂) and (X₂,Y₂) for the unique fields as above. FIG. 3 is a perspective view of a left map and right map according to selected embodiments of the current disclosure.

Further, we need to parameterize motion through the scene along various user selected paths, functionally moving the origins and requiring significant recalculation of the relative objects' shapes features and positions within the displayed video sequence for each eye.

In some embodiments, the system can function as a phone ‘App’ where the users understand that image stability and interpupillary distance are critical to simple image construction directly from the video files for display by binocular viewing means.

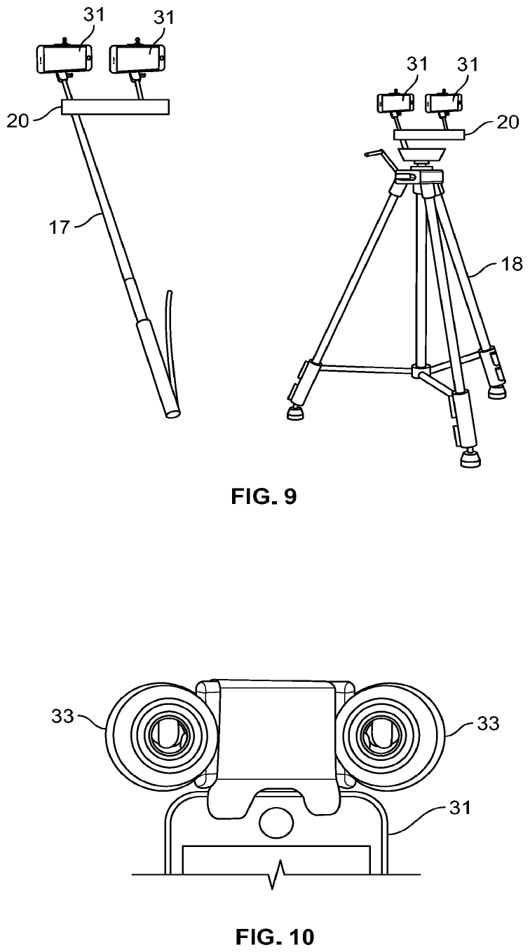

FIG. 9 is a perspective view of a dual phone mount with either a tripod or hand-held extension according to selected embodiments of the current disclosure. The tripod or hand held extension may be provided to fix interpupillary distance. This configuration would also allow users to ‘walk through’ scenes, to make stereo videos for direct, unprocessed viewing, or subsequent scene processing computations and file construction. Also achievable is a remote control connected to the phone jack to control on/off simultaneity of both capture units concurrently.

Particular embodiments of the current disclosure have a capture apparatus that includes two mobile phones with integrated cameras, where the lenses of each camera are separated by a certain distance. Each mobile phone captures a media, whereby a first media and second media are captured by the capture apparatus. A dual phone mount may be used to secure the cameras in a fixed position with the lenses of each camera a certain distance apart.

Further embodiments of the capture apparatus include a mobile phone application that uses on board WIFI utilities for the coordination of shutter and zoom controls and image uploads of two phones. This approach designates one phone as a master that in control and other (a slave) by copying the settings and timing as well as directing these activities once the photos are initiated.

A creation apparatus is also disclosed herein. The creation apparatus comprises a computerized system that includes machine readable instructions on a non-transitory medium. The instructions enable the computerized system to receive a first media and a second media and convert it into a three dimensional image or sequence of images (video) stored as an output media. A particular embodiment disclosed herein has instructions that concatenate images together to form a three-dimensional image. For example, a first image file and a second image file, each of the same dimension, are concatenated together to form a third image file that is twice the width of the first or second image file. The raw image may be twice the width of the two individual images, but for high resolution images, various compression algorithms may be employed to reduce the file size. The concatenated image may or may not be the full objective space of the original pictures, that is, the images may be cropped and still contain the concatenated 3D stereo image of interest. This approach is not generally automated.

The creation apparatus may further comprise computer readable instructions capable of recognizing objects within the media files created by the mobile phones. Pattern recognition objects from a pattern recognition database are used to determine objects within a media file. These objects are used to create three-dimensional representations of a scene in the media file, thereby allowing for the creation of side views of objects that were not previously visible by the particular media file. Furthermore, the recognized objects may be used to create two separate maps, one for each eye, that are used when displaying the output media file to a user.

The three-dimensional media file produced by the creation apparatus is displayed on a display apparatus. The display apparatus displays the output media file to a user such that the user perceives the output media file in three dimensions. For example, goggles with a display that matches dimensions of the output media file, and whose display segregates each half of the output media file to one eye of the user, may appropriately display the output media file to user such that the user perceives the resulting image as a three-dimensional view. A mobile phone may be used in conjunction with the goggles or as a part of the goggles.

Additionally, hardwired solutions for single button shutter triggering were identified and successfully tested.

FIG. 4 is a perspective view of a tripod mount with a Bluetooth trigger according to selected embodiments of the current disclosure. A tripod 18 supports a mount 20 that secures two or more image capture devices (not shown) thereto. A Bluetooth trigger 19 activates the one or more capture devices to capture a stereo image.

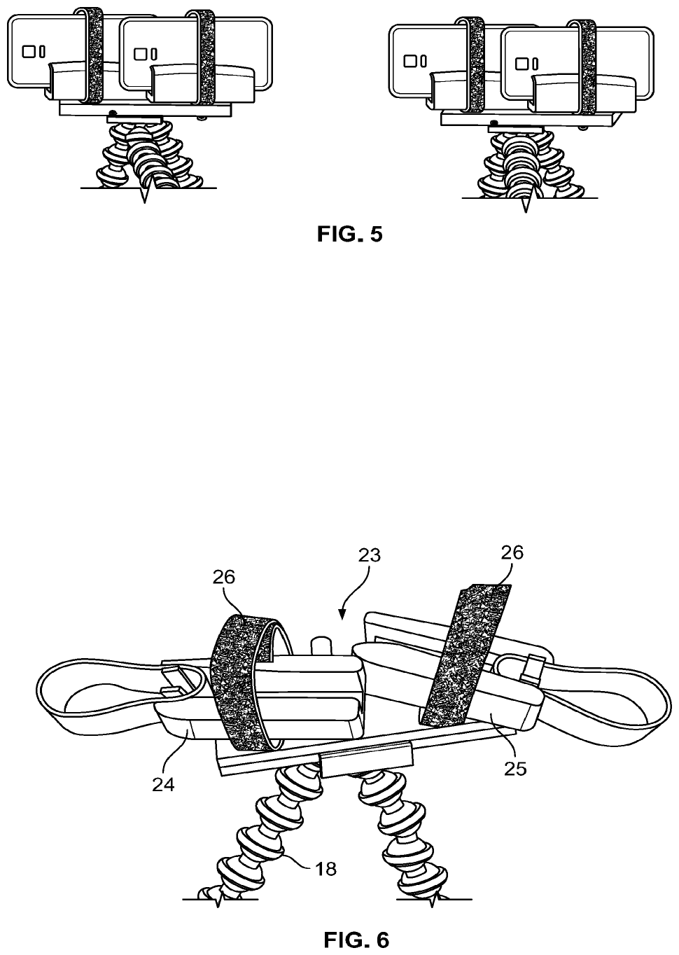

FIG. 5 is a screenshot displaying a stereo image of a self-portrait using a split rack tripod mount according to selected embodiments of the current disclosure.

FIG. 6 is a perspective view of a tripod with a split rack mount according to selected embodiments of the current disclosure. A tripod 18 supports a split rack mount 23. The split rack mount 23 includes a first mobile device mount 24 and a second mobile device mount 25. Straps 26 are used to secure mobile devices (not shown) to the respective mobile device mounts.

The dual phone mount includes a retention system. The retention system has rubber bands, Velcro bands, both, or similar straps or bands that are used in conjunction with a protective spacer between the mobile phones. Alternatively, the retention system may use hook and loop fasteners, magnets, friction strips, or similar contact retention strips for restraining the mobile phones to the mount. Slotted brackets within a trough may be used to allow for variable wall spacing for phones with different thicknesses and for precise mating with the mount. The dual phone mount may also include an adjustment system. The adjustment system has a split rack, that is, two racks that are independent of the other, each capable of holding and retaining a mobile phone. Each rack of the split rack has a rotational degree of freedom allowing the axis of each camera of each mobile phone to cross, that is, be non-parallel. This allows for close-ups with zoom. Placement of a rubber band, approximately one-inch in width, around the mobile phones to provide a restorative force pulling the mobile phones together allows for a smooth motion of the mobile phones' cameras relative horizontal spacing when zooming. Furthermore, the spacer is located within the band's loop to prevent additional movement after the desired setting is achieved, or to prevent the mobile phones from moving too close together. The retention system may include linear and angular measurement markings along its length to provide quantitative estimates and guidance for quick pre-set values, although often it is possible to align images visually.

Particular embodiments provide for a grip portion, where the grip portion is attached to a bracket portion, and the bracket portion comprises a front section, a back section, two end sections, a trough, and means of adjustment, where the trough comprises a cavity bounded by the front section, the back section, the two end sections, and a bottom section, where a user can place two cell phones in the trough and adjust their location relative to one another through the means of adjustment.

The dual phone mount, in particular embodiments, sets the lenses of each camera of each mobile phone between 6.5 centimeters and 13.0 centimeters apart. As discussed above, the distance between the lenses of each camera may be varied by varying the distance between the mobile phones.

WIFI links can be used for on-board processing in a phone App. This approach, when considered in the context of existing display technologies, can be used not only for virtual presence for anyone, but also as a prosthetic for visually impaired persons, as it allows for inline enhancements of brightness and contrast, potentially with edge enhancements and artificial color for those who would like or need better views of their own environment. It will be a primary goal of this effort to provide this functionality.

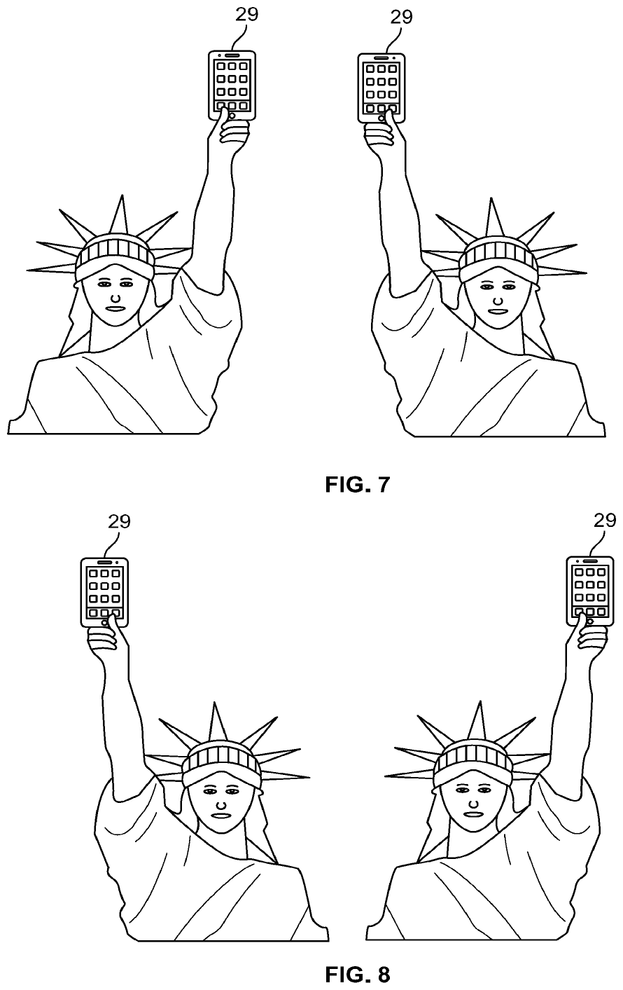

Turning to FIGS. 7 and 8, the basic process of one embodiment of the invention is illustrated. Two separate video files taken from two separate cameras 29 are recorded or streamed. The customer who recorded the images then sends the individual files to a processing station, which then creates temporal overlap files. The processing center then creates a single file from the two aligned videos or still images. The processing center than uses the software of the invention to form a single image or video file from the two aligned videos or still images, which is sent back to the customer, sent to another email address, posted to the internet or whatever eventual depository is selected by the customer. One characteristic of the process is to vertically align features of the two images to the same row number of the respective images. Another aspect of the process is to place features of the images at suitable scale for the image such that the features are spaced consistent with its normal parallax angles and size viewing as merged stereo 3D files through binocular viewing means. This feature helps abate motion sickness associated with conventional 3D stereo viewing.

Capture configurations as shown in FIG. 8 provide “pseudo-stereo” 3D Stereo images not consistent with normal viewing with respect to scale, parallax angles and associated hidden-line-suppression. As shown, the resultant image will appear to have been captured from further away from the subject of the image and will make the subject appear, not simply further away, but smaller than they would normally be perceived. Note that the median human interpupillary distance is around 65 millimeters, as should be the spacing of the camera lenses in these mountings and hand held camera usage for stereo “Selfies”. Variations on this distance may be preferred by some individuals whose interpupillary distance is significantly different from this average. The mounting systems shown below should be able to accommodate variations in intercamera aperture distance consistent with the population's distribution.

FIG. 9 shows a dual phone mount on a tripod and an extension according to selected embodiments of the current disclosure. Two cell phones 31 are secured to a mount 20 and arranged such that the two lenses are approximately the same interpupillary distance as the user's eyes. Once the cell phones are properly spaced, the unit, in this embodiment of the invention, is a hand-held device with a grip 17 or a tripod and a spacing/securing tray acting as a mount 20. This view presents an apparatus for forming a fixed interpupillary distance for two camera phones. Particular embodiments provide for the mount being used interchangeably with the hand-held device with a grip 17, sometimes also referred to as a “selfie-stick,” and the tripod 18.

Also, as shown in FIG. 6, it is noted that for small objects to be placed closer than phones parallel to one and other can capture, a ‘Split rack’ which holds the two phones independently, the optical axes of the two cameras can be crossed allowing for stereo imaging of such objects.

FIG. 10 shows a 360 degree stereo 3D image/video capture system according to selected embodiments of the current disclosure. The two cameras are placed at a fixed distance from one and other, approximately equal to the distance between human eyes for view realism regarding size of apparent objects, and the outputs from two 360 degree cameras 33 are combined into a single Stereo 3D world view. The Left-Right designation must be switched for objects behind one with respect to objects in front of one for display on conventional stereo viewers. Overlapping areas in the perceived stereo viewing field will get twice the apparent image resolution. This approach is applicable to two-phone solutions and is applicable to a single phone adapter providing 360 degree stereo 3D viewing with enhanced image resolution, as shown in this figure.

A computer system for generating an output media file, in certain embodiments, includes instructions to place the left image on the left field of view, and the right image on the right field of view in the concatenated image. Then, the computer system should align objects in the respective images so that the subject elements are at approximately the same vertical height in the concatenated image of both the top and bottom of the subjects. This means that the apparent top of the objects are at the same line number in the concatenated image and that the images are scaled so that the objects are of the same approximate scale, and so that the horizontal-vertical scale proportionality is maintained for any vertical scaling adjustment (vertical-only image stretching is not suitable and will result in adverse viewing effects). The resultant smaller image is the maximum extent of the stereo 3D effect, and any area not encompassed by the smaller image can be cropped out of the final produced image concatenation. Apparent horizontal scale should not be considered when aligning or scaling the left and right images. The concatenated image can then be moved in its entirety such that the vertical center of the mage is at the vertical center of the displayed field of view. Differences in left and right image resolution after scaling may be ignored, but will result in differences in the left and right resolutions in the concatenated image.

Object recognition software exists from third parties for the purposes of completing un-captured perspective views of virtual environments, including software created by Dynamic Ventures, Inc. and Facebook, Inc.

While various embodiments of the present invention have been described above, it should be understood that they have been presented by way of example only, and not of limitation. Likewise, the various diagrams may depict an example architectural or other configuration for the invention, which is provided to aid in understanding the features and functionality that can be included in the invention. The invention is not restricted to the illustrated example architectures or configurations, but the desired features can be implemented using a variety of alternative architectures and configurations.

Indeed, it will be apparent to one of skill in the art how alternative functional configurations can be constructed to implement the desired features of the present invention. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

That which is claimed:

1. An apparatus for capturing stereo images comprising
a mount, where the mount comprises a first rack and a second rack, where each rack comprises a retention mechanism; and
a first camera and a second camera, where the first camera is secured to the first rack by the retention mechanism of the first rack, and where the second camera is secured to the second rack by the retention mechanism of the second rack, where each camera comprises a lens, where the lenses are a certain distance from each other.

2. The apparatus of claim 1, wherein a distance between each rack is adjustable thereby adjusting the distance between each lens.

3. The apparatus of claim 2, wherein the distance between each lens is between 65 mm and 130 mm, inclusive.

4. The apparatus, of claim 1, wherein the lenses are at a distance from each other of between 60 mm and 70 mm, inclusive.

5. The apparatus of claim 1, wherein the first camera is a first mobile phone and the second camera is a second mobile phone.

6. The apparatus of claim 1, wherein the first camera is a first 360 degree camera, and where the second camera is a second 360 degree camera.

7. The apparatus of claim 1, wherein each rack has a separate rotational degree of freedom allowing each rack to rotate independently.

8. A system for generating stereo image or video files from separate capture sources comprising
a capture system having a first camera and a second camera, where the capture system generates a first media and a second media, where the first media comprises image or video data from the first camera, and where the second media comprises image or video data from the second camera,
a computer system comprising one or more processors executing programming logic, the programming logic configured to:
recognize objects in the first media and second media and retrieving pattern recognition objects from pattern recognition databases;
take the first media, second media and the pattern recognition objects, and creating a three dimensional representation of an entire scene, including both the side views of objects originally contained in the first media and second media as well as side views of objects created by the software from the pattern recognition objects;
take both the side views of objects originally contained in the first media and second media as well as side views of objects created by the software from the pattern recognition objects, and combining these into two separate maps, one for each eye;
identify discrepancies in the objects between the first media and second media, and correcting these discrepancies by comparing the first media and the second media; and
generate an output media having a stereo image or video file, and
a display system for displaying the output media.

9. The system of claim 8, wherein the first media comprises video data, and where the programming logic is further configured to vary the frame rate of video data within the first media based upon available light.

10. The system of claim 8, wherein the programming logic is further configured to create a scene through spatial map construction using the first media from both cameras.

11. The system of claim 8, wherein the programming logic is further configured to create a virtual reality environment through backside image additions by retrieving object recognition data from one or more object recognition databases.

12. The system of claim 8, wherein each camera of the capture system is a mobile phone.

13. The system of claim 8, wherein each camera of the capture system is a 360 degree camera.

14. The system of claim 8, wherein the display system is a mobile phone.

15. The system of claim 8, wherein the display system is a set of goggles, where the goggles comprises a first display for displaying an image to a first eye of a user, and a second display for displaying an image to a second eye of a user.

16. The system of claim 8, wherein each camera of the capture system comprises a lens, wherein the lenses are at a distance from each other of between 60 mm and 70 mm, inclusive.

17. A method of providing a three-dimensional stereo viewing experience, comprising the steps of, in order:
first, securing two cameras to an adjustable mount;
second, capturing two sets of pictures or videos using the cameras from adjustably different perspectives;
third, transmitting the two sets of pictures or videos to a processing center;
fourth, identifying temporal overlap in the two sets of pictures or videos and creating a temporal overlapped series of pictures or videos;
fifth, creating a single file from the temporal overlapped series of pictures or videos;
sixth, forming a single image or video file;
seventh, transmitting the single image or video file to a customer.

18. The method of claim 17, wherein each camera is a mobile phone.

19. The method of claim 17, wherein each camera is a 360 degree camera.

20. The method of claim 17, wherein the mount comprises a strap, band or bracket.
